(19) United States
(12) Patent Application Publication
(10) Pub. No.: US 2004/0101702 A1
(43) Pub. Date: May 27, 2004

(54) Magnetic tunnel junction device and method for fabricating the same

(76) Inventors: Tae-Wan Kim, Anyang-city (KR); Beong-Ki Cho, Kwangju (KR); Hee-Jae Shim, Kwangju (KR)

Correspondence Address: LEE & STERBA, P.C., 1101 Wilson Boulevard, Suite 2000, Arlington, VA, 22209, US

(21) Appl. No.: 10/713,215

(22) Filed: Nov. 17, 2003

(30) Foreign Application Priority Data
Nov. 15, 2002 (KR) 2002-71046

(51) Int. Cl. B32B 25/04

(52) U.S. Cl. 428/492

(57) ABSTRACT

Provided are a magnetic tunnel junction (MTJ) device and a method for fabricating the same. The MTJ device includes a substrate, and a fixed layer, a tunnel barrier, and a free layer sequentially stacked on the substrate. A magnetoresistance buffer layer formed of a metallic nitride is interposed between the fixed layer and the tunnel barrier. The entire MTJ device is thermally treated to reduce a magnetic junction resistance thereof. Nitrogen in the magnetoresistance buffer layer having a predetermined thickness is combined with elements of the tunnel barrier, thus improving uniformity of the tunnel barrier. Further, by performing nitrogen plasma processing and a thermal treatment, a high-performance MTJ device with a high MR ratio and a low RA value can be fabricated.

### BACKGROUND OF THE INVENTION

1. Field of the Invention

The present invention relates to a magnetic tunnel junction (hereinafter, referred to as an “MTJ”) device and a method for fabricating the same. More particularly, the present invention relates to an MTJ device with a reduced junction resistance and a method for fabricating the same.

2. Description of the Related Art

An MTJ device is a junction structure including a sandwich of two ferromagnetic layers separated by a thin insulating layer, in which the amount of tunneling current is varied according to a relative magnetic direction of each of the ferromagnetic layers. The MTJ device has been used in a nonvolatile magnetic memory device, a read head of a highly integrated magnetic storing medium, and the like, and has recently attracted scientific attention due to a phenomenon depending not on electric charges but on electric spins.

To embody a high-performance highly integrated magnetic memory device, an MTJ device with a high magnetoresistance (MR) and a low junction resistance is required. In particular, the resistance-area (RA) value, obtained by multiplying the resistance value of an MTJ by the area of the MTJ, is an important variable that determines the signal to noise (S/N) ratio and the resistance capacitor (RC) time constant.

FIG. 1 is a graph showing the RA value of a typical MTJ device with respect to the thickness of an Al₂O₃ layer, which is used as an insulating tunnel barrier in the typical MTJ device.

Referring to FIG. 1, as the thickness of the Al₂O₃ layer increases by 3 Å, the RA value sharply increases from 10³ to 10⁴ Ωμm². In general, the RA value of a magnetic memory device is less than 10 Ωμm², and the RA value of a read head is preferably less than 10 Ωμm². Since the RA value depends on the type and thickness of a tunnel barrier, in a conventional method for fabricating an MTJ device, an Al₂O₃ layer having a high MR ratio is used as a tunnel barrier and is uniformly formed to a thin thickness of 1 mm or less. In this case, however, the thin tunnel barrier has poor uniformity, thus degrading the performance of the MTJ device.

Even though methods for reducing the RA value to several tens of Ωμm² have been extensively investigated, an MTJ device having a low RA value still cannot maintain an optimized high MR ratio. Accordingly, an MTJ device including a tunnel barrier having a predetermined thickness to obtain good uniformity, and having a high MR ratio and a low RA value is needed.

### SUMMARY OF THE INVENTION

The present invention provides an MTJ device with a reduced magnetic tunnel junction resistance and good uniformity and a method for fabricating the same.

In accordance with a feature of an embodiment of the present invention, there is provided an MTJ device including a substrate and a fixed layer, a tunnel barrier, and a free layer sequentially stacked on the substrate, wherein a magnetoresistance buffer layer formed of a metallic nitride is interposed between the fixed layer and the tunnel barrier, and the entire magnetic tunnel junction device is thermally treated to reduce the magnetic junction resistance thereof. Preferably, nitrogen is combined with elements of the tunnel barrier during the thermal treatment to form a nitrogen rich layer at the tunnel barrier.

The fixed layer preferably includes a seed layer, a pinning layer, and a pinned layer, which are sequentially deposited. The seed layer is preferably a ferromagnetic layer formed of one selected from the group consisting of NiFe, Ru, and Ir. The pinning layer is preferably a semi-ferromagnetic layer formed of one selected from the group consisting of FeMn and IrMn. The pinned layer is preferably a ferromagnetic layer formed of one selected from the group consisting of NiFe and CoFe. The magnetoresistance buffer layer is preferably a metallic nitride layer formed of FeN. The tunnel barrier is preferably an insulating layer formed of AlOₓ. The thermal treatment preferably includes heating the magnetic tunnel junction device at a temperature of 150 to 300° C. and slowly cooling the magnetic tunnel junction device.

In accordance with another feature of an embodiment of the present invention, there is provided a method for fabricating an MTJ device, which includes (a) depositing a fixed layer on a substrate and processing the surface of the fixed layer using nitrogen plasma, (b) sequentially stacking a tunnel barrier, a free layer, and a capping layer on the fixed layer and thermally treating the tunnel barrier, the free layer, and the capping layer to thereby fabricate the MTJ device with a reduced magnetoresistance.

The fixed layer, the tunnel barrier, the free layer, and the capping layer are preferably deposited by sputtering.

In (a), the nitrogen plasma processing preferably includes applying a direct power to a nitrogen atmosphere under a predetermined pressure to generate nitrogen plasma and bringing the nitrogen plasma into contact with the fixed layer.

In (b), the thermal treatment preferably includes heating and then slowly cooling the tunnel barrier, the free layer, and the capping layer one or more times, wherein each heating is performed at a temperature between 150° C. and 300° C. Also in (b), a magnetic field is preferably applied to the MTJ device during the thermal treatment. The thermal treatment preferably leads nitrogen to combine with elements of the tunnel barrier.

The fixed layer preferably includes a seed layer, a pinning layer, and a pinned layer, which are sequentially stacked on the substrate.

Here, the seed layer is preferably a ferromagnetic layer formed of one of NiFe, Ru, and Ir, the pinning layer is preferably a semi-ferromagnetic layer formed of one selected from the group consisting of FeMn and IrMn, and the pinned layer is preferably a ferromagnetic layer formed of one selected from the group consisting of NiFe and CoFe.

The magnetoresistance buffer layer is preferably a metallic nitride layer formed of FeN, and the tunnel barrier is preferably an insulating layer formed of AlOₓ.

According to the present invention, the top surface of a fixed layer is processed with nitrogen plasma, and after a tunnel barrier is deposited on the fixed layer, an MTJ device is thermally treated. Thus, the MTJ device with a reduced magnetic junction resistance can be fabricated.

### BRIEF DESCRIPTION OF THE DRAWINGS

The above and other features and advantages of the present invention will become more apparent by describing in detail preferred embodiments thereof with reference to the attached drawings in which:

FIG. 1 is a graph showing the RA value in a typical MTJ device with respect to the thickness of an Al₂O₃ layer, which is used as an insulating tunnel barrier in the typical MTJ device;

FIG. 2 illustrates a sectional view of an MTJ device according to an embodiment of the present invention;

FIGS. 3A through 3E are sectional views illustrating a method for fabricating the MTJ device of FIG. 1 according to an embodiment of the present invention;

FIG. 4 is a scanning electron microscopy (SEM) photograph of an MTJ device according to an embodiment of the present invention;

FIG. 5A is a graph showing an MR ratio with respect to the temperature of the thermal treatment of the MTJ device of FIG. 3 before and after nitrogen plasma processing;

FIG. 5B is a graph showing a ratio of RA at various temperatures to RA at absolute zero RA/RA(Ta=0° K) with respect to the temperature of the thermal treatment of the MTJ device of FIG. 3 before and after nitrogen plasma processing;

FIG. 6A is a graph showing a ratio of MR at different temperatures to MR at a temperature where the bias voltage is equal to OV MR/MRₜ(V=0) with respect to bias voltage at different temperatures during the thermal treatment;

FIG. 6B is a graph showing a positive voltage or a negative voltage V_{1/2MR} measured when the MR ratio decreases to half the maximum value of the MR ratio;

FIG. 7A is a graph showing a change in binding energy of FeN and AlN;

FIG. 7B is a graph showing a change in binding energy with respect to the exposure time tₑₓ of the MTJ device including Ta/NiFe/FeMn/NiFe/(N₂ plasma processing)/Al (1.32 nm) to nitrogen plasma;

FIG. 8A is a graph showing the MR ratio with respect to the temperature of the thermal treatment at different exposing times tₑₓ to the nitrogen plasma in the MTJ device including Ta/NiFe/FeMn/NiFe/(N₂ plasma processing)/AI (1.32 nm) and oxide/NiFe/Au;

FIG. 8B is a graph showing the RA value with respect to the temperature of the thermal treatment at different exposing times tₑₓ to the nitrogen plasma in the MTJ device having Ta/NiFe/FeMn/NiFe/(N₂ plasma processing)/Al (1.32 nm) and oxide/NiFe/Au; and

FIG. 9 is a graph showing a change in binding energy before an MTJ device including Ta/NiFe/FeMn/NiFe/Fe is processed with nitrogen plasma and after the MTJ device is exposed to the nitrogen plasma for 30 seconds.

### DETAILED DESCRIPTION OF THE INVENTION

Korean Patent Application No. 2002-71046, filed on Nov. 15, 2002, and entitled: “Magnetic Tunnel Junction Device And Method For Fabricating The Same,” is incorporated by reference herein in its entirety.

An MTJ device and a method for fabricating the same according to an embodiment of the present invention will be described more fully hereinafter with reference to the accompanying drawings, in which preferred embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like numbers refer to like elements throughout.

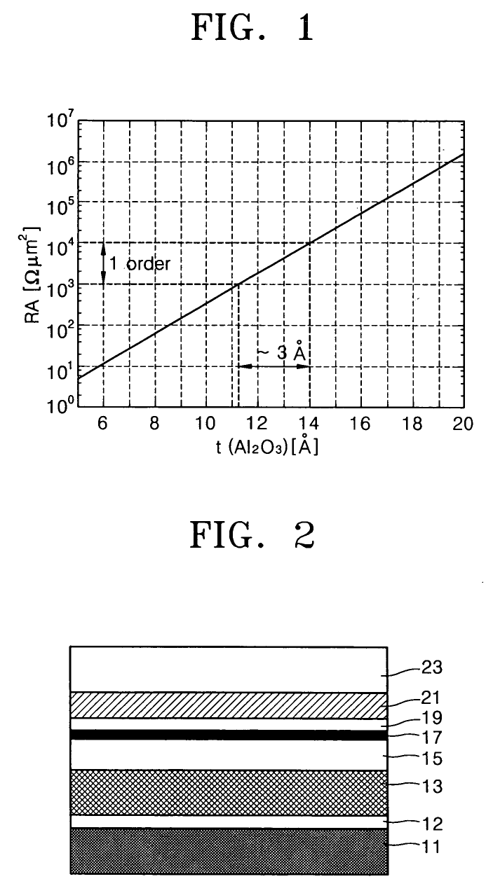

FIG. 2 is a sectional view of an MTJ device according to an embodiment of the present invention.

Referring to FIG. 2, a seed layer 12, a pinning layer 13, a pinned layer 15, a magnetoresistance buffer layer 17, a tunnel barrier 19, a free layer 21, and a capping layer 23 are sequentially stacked on a substrate 11, thereby forming the MTJ device.

The seed layer 12 is formed of one of NiFe, Ru, and Ir, the pinning layer 13 is formed of a semi-ferromagnetic material such as FeMn and IrMn, and the pinned layer 15 is formed of a fixed ferromagnetic layer such as NiFe and CoFe.

Unlike conventional MTJ devices, the MTJ device according to the present invention further comprises a magnetoresistance buffer layer 17 between the pinned layer 15 and the tunnel barrier 19. The magnetoresistance buffer layer 17 is formed of a nitride such as FeN, which is obtained by processing the top surface of the pinned layer 15 using nitrogen plasma.

The tunnel barrier 19 is formed using AlOₓ or AlNₓOₓ on the magnetoresistance buffer layer 17. The free layer 21 is formed using a ferromagnetic material such as NiFe on the tunnel barrier 19. Also, the capping layer 23 is formed using Ru on the free layer 21.

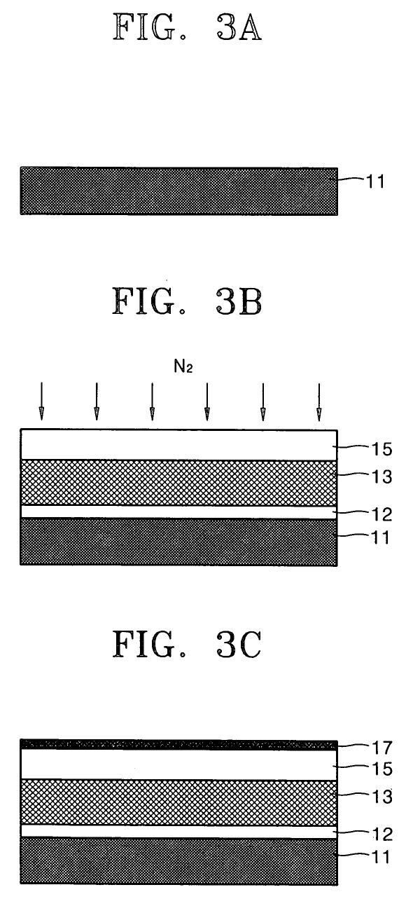

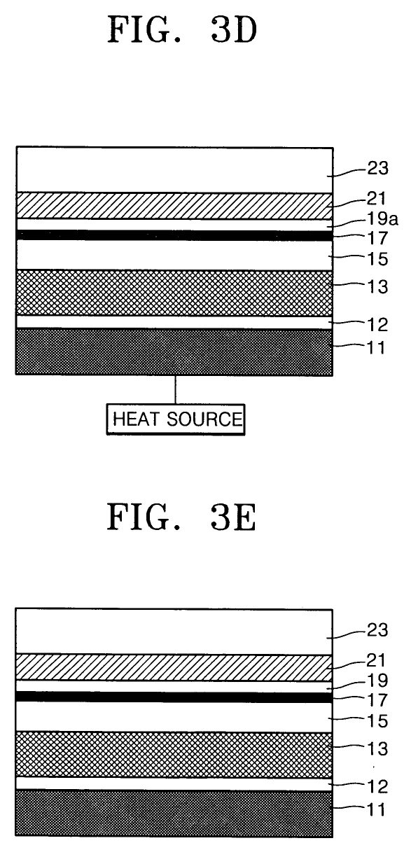

FIGS. 3A through 3E are sectional views illustrating a method for fabricating the MTJ device according to the embodiment of the present invention.

As shown in FIG. 3A, the substrate 11 is prepared, and the seed layer 12, the pinning layer 13, and the pinned layer 15 are sequentially deposited on the substrate 11 using a magnetron sputtering system. Here, each of the layers is deposited to a thickness of several to several tens of nanometers.

Next, the surface of the pinned layer 15 is processed with nitrogen plasma, thereby forming the magnetoresistance buffer layer 17, as shown in FIG. 3C. After forming the magnetoresistance buffer layer 17, a tunnel barrier 19a, the free layer 21, and the capping layer 23 are sequentially deposited using sputtering, and then are thermally treated by connecting a heat source. A predetermined magnetic field is applied to the resultant structure during the thermal treatment, which includes heating the resultant structure several times, each time at a different temperature of from 150° C. to 300° C., and slowly cooling the resultant structure after each heating. Once the MTJ device is heated at a predetermined temperature for a predetermined time, nitrogen penetrates into the tunnel barrier 19a and combines with elements of the tunnel barrier 19a. Thus, the tunnel barrier 19a is changed into the tunnel barrier 19 having a different atomic structure than that of the tunnel barrier 19a. FIG. 3E shows a completed MTJ device, which has the same structure as the MTJ device shown in FIG. 2.

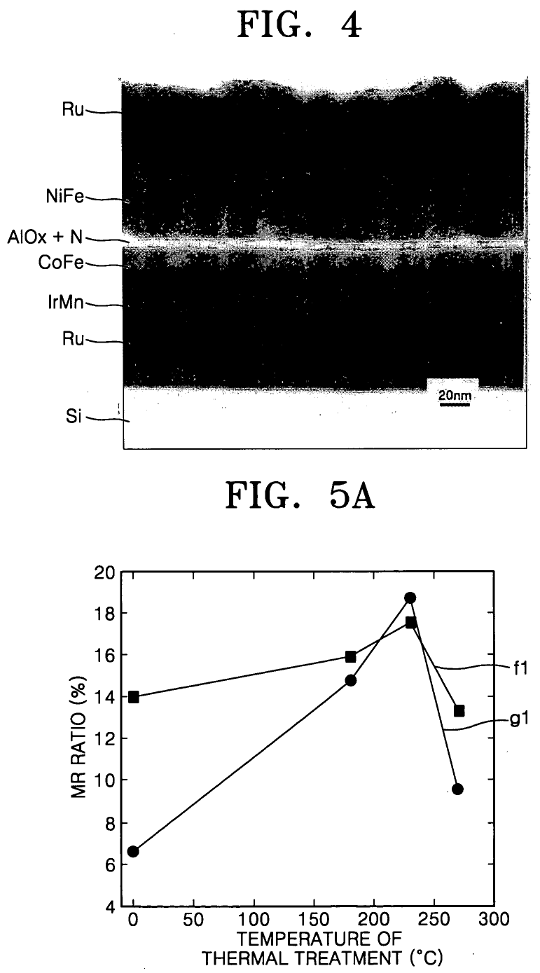

FIG. 4 is an SEM photograph of the MTJ device according to an embodiment of the present invention.

Referring to FIG. 4, a seed layer formed of Ru, a pinning layer formed of IrMn, and a pinned layer formed of CoFe are sequentially deposited on a substrate. Here, the seed layer, the pinning layer, and the pinned layer are formed to a thickness of 19 nm, 17 nm, and 5 nm, respectively. Afterwards, a magnetoresistance buffer layer is formed on the resultant structure by processing the top surface of the pinned layer using nitrogen plasma, and a tunnel barrier is formed using AlOₓ on the magnetoresistance buffer layer. In FIG. 4, the magnetoresistance buffer layer and the tunnel barrier are illustrated together as AlOₓ+N. A free layer formed of NiFe is deposited on the tunnel barrier to a thickness of 25 nm, and a capping layer formed of Ru is deposited on the free layer to a thickness of 18 nm. Then, the resultant structure is thermally treated to lead nitrogen in the magnetoresistance buffer layer to combine with elements of the tunnel barrier. As a result, a high-performance MTJ device with a reduced magnetoresistance is fabricated.

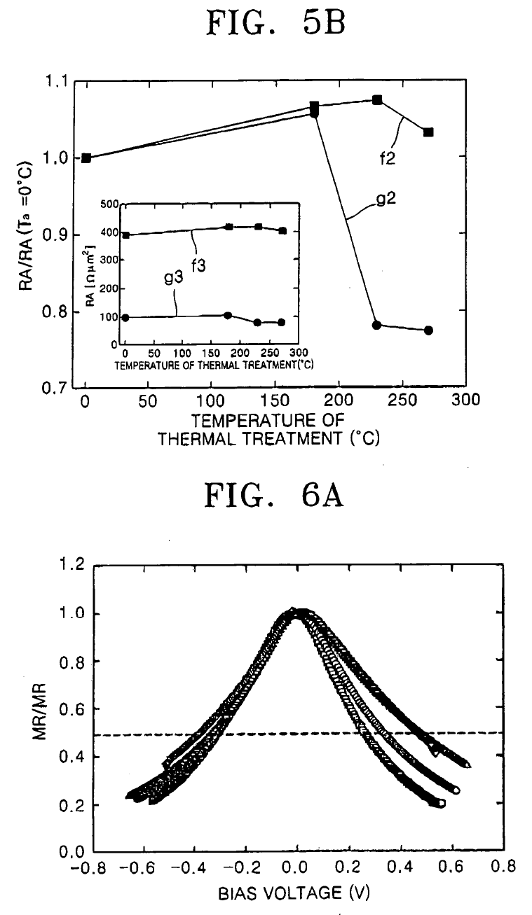

FIGS. 5A and 5B are graphs showing an MR ratio and RA at various temperatures to RA at absolute zero RA/RA(Ta=0° K), respectively, with respect to the temperature of the thermal treatment of the MTJ device of FIG. 3E before and after the nitrogen plasma processing.

A seed layer formed of Ta, a pinning layer formed of NiFe, a pinned layer formed of FeMn, and a buffer layer NiFe are sequentially deposited on an Si/SiO₂ substrate using a dc or rf magnetron sputtering system having a degree of vacuum of 8×10⁻⁸ Torr or less. Here, the seed layer, the pinning layer, the pinned layer, and the buffer layer are formed to a thickness of 10 nm, 14 nm, 10 nm, and 6 nm, respectively. Then, immediately after depositing the seed layer, the pinning layer, the pinned layer, and the buffer layer, the nitrogen plasma processing is conducted using a direct power of 3.5 W under a pressure of 100 mTorr in an atmosphere of N₂.

Next, an Al layer, a NiFe layer, and an Au layer are deposited by sputtering to thicknesses of 1.58 nm, 20 nm, and 20 nm, respectively, and then are thermally treated. The thermal treatment is carried out in a vacuum state having a pressure of 5×10⁶ Torr. During the thermal treatment, a magnetic field having 150 Oe is applied in parallel with the magnetic axis of the resultant structure. The thermal treatment includes heating the resultant structure, where the Al layer, the NiFe layer, and the Au layer are formed, three times, for a duration of 30 minutes each time, at temperatures of 180° C., 230° C. and 270° C., respectively, and slowly cooling the resultant structure after each heating.

The resultant MTJ device includes Ta/NiFe/FeMn/NiFe/Al₂O₃/NiFe/Au. All properties of the MTJ device are measured using a direct four-electrode method at a normal temperature, i.e., room temperature.

FIG. 5A shows the MR ratio with respect to the temperature of the thermal treatment of a nitrogen-unprocessed junction f1 and a nitrogen-processed junction g1.

The MR ratio is defined in Equation 1 as:

$$MRratio = \frac{{R}_{ap} - {R}_{p}}{{R}_{p}} \qquad ( 1 )$$

In Equation 1, Rₐₚ is the resistance of the MTJ in a case where a magnetic direction of the pinned layer is not parallel with that of the free layer, while Rₚ is the resistance of the MTJ in a case where a magnetic direction of the pinned layer is parallel with that of the free layer. As the MR ratio increases, it is easier to determine a direction of spin in each of the pinned layer and the free layer. Thus, data recorded in bits of the MTJ device can be read out at a high speed.

As shown in FIG. 5A, before the thermal treatment, even though the junction g1 is processed using nitrogen plasma for 10 seconds, the junction g1 has an MR ratio of 6.6%, which is even lower than that of the nitrogen-unprocessed junction f1 at 14%. This may be because different states such as FeN and NiNy are generated on the surface of the NiFe layer by the nitrogen plasma, and thus the state density is varied at the interfaces between the Al₂O₃ layer and the NiFe layer.

As the temperature of the thermal treatment is increased up to 230° C., the MR ratio of the nitrogen-unprocessed junction f1 increases from 14% to 17.5%. However, as the temperature of the thermal treatment becomes higher than 230° C., the MR ratio begins to decrease. A similar temperature change in the thermal treatment of the nitrogen-processed junction g1 results in the MR ratio of the nitrogen-processed junction g1 being varied within a much wider range than that of the nitrogen-unprocessed junction f1. When the thermal treatment is performed at 230° C., the MR ratio of the nitrogen-processed junction g1 is 18.7%, which is higher than that of the nitrogen-unprocessed junction f1 under the same conditions. The sharp increase in the MR ratio of the nitrogen-processed junction g1 in response to the thermal treatment indicates that the Al₂O₃ layer is uniformly formed by redistribution of oxygen, and that interfacial characteristics between the tunnel barrier and the pinned layer are improved due to a change in distribution of nitrogen affecting the pinned layer.

FIG. 5B shows a ratio of RA at various temperatures to RA at absolute zero RA/RA(Ta=0° K) of the MTJ device with respect to the temperature of the thermal treatment of the nitrogen-unprocessed junction f2 and the nitrogen-processed junction g2 of FIG. 5A. The inner graph shows an absolute RA value after the thermal treatment (Ta=0° K). Curve f3 denotes the absolute RA value of the nitrogen-unprocessed junction, while g3 denotes the absolute RA value of the nitrogen-processed junction. The RA value is measured in the case where a magnetic direction of the free layer is parallel with that of the fixed layer.

Referring to the inner graph, before the thermal treatment, the RA value of the nitrogen-unprocessed junction f3 is 390 kΩμm². As the temperature of the thermal treatment increases, the RA value also increases up to 418 kΩμm² at a temperature of 230° C. where the MR ratio has a maximum. As the temperature of the thermal treatment becomes higher than 230° C., the RA value decreases again. This change in the graph is similar to that of the nitrogen-unprocessed junction f1 shown in FIG. 5A. If the temperature is increased up to 230° C., since the distribution of oxygen in the Al₂O₃ tunnel barrier becomes uniform, both the MR ratio and the RA value increase. However, in a case where the temperature is increased beyond 230° C., metallic impurities penetrate into the tunnel barrier, thus lowering the MR ratio and the RA value.

Before the thermal treatment, the RA value of the nitrogen-processed junction g3 is 100 kΩμm², which is less than that (390 kΩμm²) of the nitrogen-unprocessed junction f3. The RA value of the nitrogen-processed junction g3 increases slightly until the temperature reaches 180° C., and then the RA value of the nitrogen-processed junction g3 decreases to 78 kΩμm², which is less than the RA value (100 kΩμm²) obtained before the thermal treatment.

The large decrease in the RA values is because nitrogen, which was mostly distributed between the NiFe layer and the Al₂O₃ layer by the nitrogen plasma processing, is redistributed by the thermal treatment. As shown in the graph, since the RA value of the nitrogen-processed junction g3 is lower before the thermal treatment, when the Al layer is deposited, the nitrogen, which contacts the surface of the NiFe layer by the nitrogen plasma processing, is assumed to be partially used to form the AlN. Also, it is inferred that when the thermal treatment is performed at 230° C., more nitrogen flows into the Al₂O₃ layer to increase the MR ratio and decrease the RA value, thus enabling an optimum distribution of nitrogen. The above inferences are valid considering a thermodynamic result that the enthalpy (−76 Kcal/mol) required for forming AlN is lower than that required for forming a transitional metallic nitride, such as FeN₄ (−2.5 Kcal/mol) or Ni₃N (0.2 Kcal/mol), which may be formed on the surface of the NiFe.

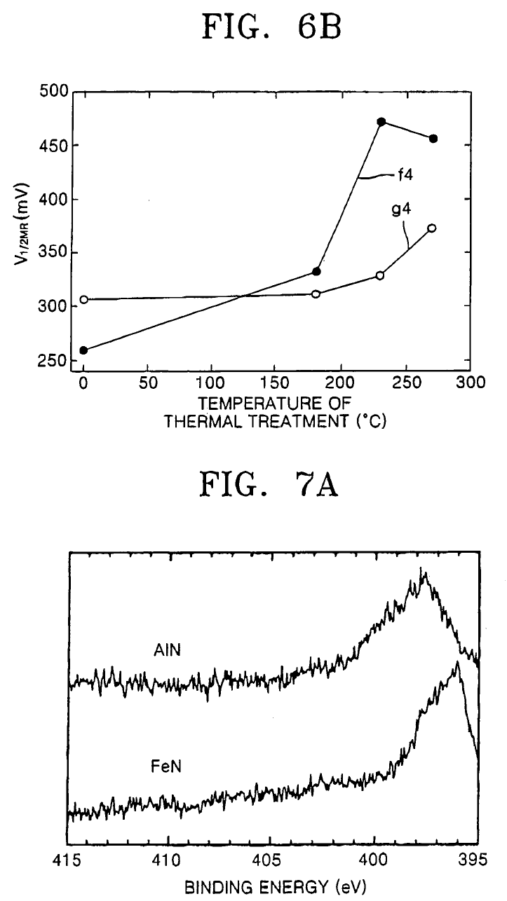

FIG. 6A is a graph showing a ratio MR/MRₜ, with respect to the bias voltage at different temperatures during the thermal treatment. FIG. 6B is a graph showing a positive voltage or a negative voltage V_{1/2MR} measured when the MR ratio decreases to half the maximum value of the MR ratio.

Referring to FIG. 6A, the MR ratio of the nitrogen-processed junction with respect to the voltage is shown before (0° C.) and after the thermal treatment (180° C., 230° C., and 280° C.). After the thermal treatment, the MR ratio depends on the voltage asymmetrically with respect to both a positive voltage and a negative voltage. The nitrogen plasma processing of the pinned layer degrades the MR ratio and the variation of the MR ratio with the voltage.

Referring to FIG. 6B, f4 shows V_{1/2MR} with respect to the temperature of the thermal treatment at a positive voltage, and g4 shows V_{1/2MR} with respect to the temperature of the thermal treatment at a negative voltage. As shown in FIG. 6B, when the thermal treatment is performed at 180° C., V_{1/2MR} (f4) at the positive voltage is slightly higher than that of (g4) at the negative voltage. This shows a different asymmetric variation from that of the voltage measured before the thermal treatment (0°). When the thermal treatment is performed at 230° C., V_{1/2MR} (f4) at the positive voltage increases within a greater range than V_{1/2MR} (g4) at the negative voltage. Thus, a difference of V_{1/2MR} between the positive voltage and the negative voltage occurs at 143 mV. In the MTJ device according to an embodiment of the present invention, V_{1/2MR} (f4) at the positive voltage, which is reduced due to the nitrogen processing, is sharply increased due to the thermal treatment. This result is related to the influence of nitrogen that moves from the NiFe layer processed with nitrogen plasma to the Al₂O₃ layer.

FIG. 7A is a graph showing a change in binding energy of reference FeN and reference AlN. FIG. 7B is a graph showing a change in binding energy with respect to an exposure time tₑₓ of the MTJ device including Ta/NiFe/FeMn/NiFe/(N₂ plasma processing)/Al (1.32 nm) to nitrogen plasma.

Referring to FIG. 7A, the binding energy of reference FeN has a peak at 396 eV, and the binding energy of reference AlN has a peak at 398 eV. FIG. 7B shows cases where the exposure time tₑₓ is 0 second, 10 seconds, 30 seconds, and 60 seconds, respectively, according to the present invention. As shown in FIG. 7B, as the exposure time increases, a second, increasingly distinctive peak is obtained at 396 eV where the binding energy of reference FeN reaches a peak. In other words, as the foregoing MTJ device is processed with nitrogen plasma for a longer time, the FeN layer (i.e., the magnetoresistance buffer layer) is more greatly increased.

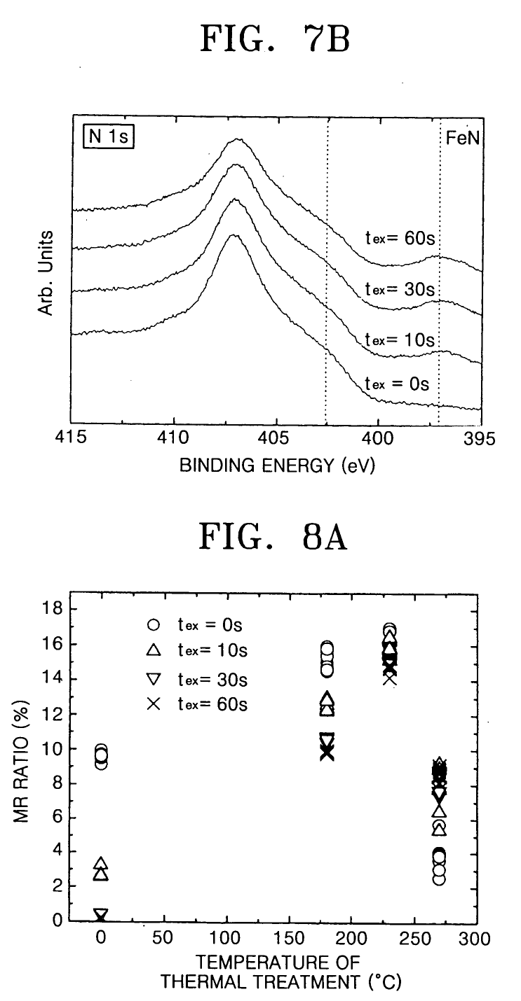

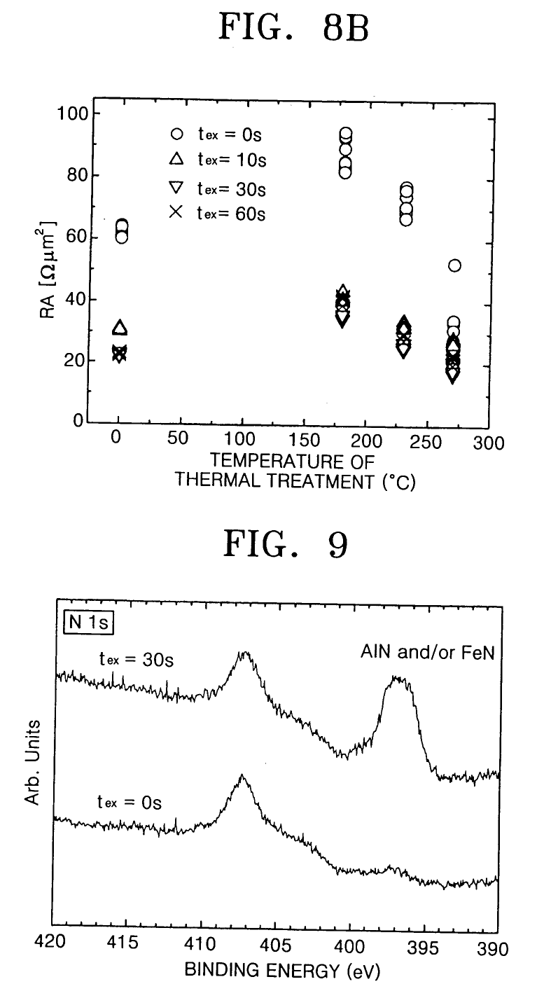

FIGS. 8A and 8B are graphs showing the MR ratio and the RA value, respectively, with respect to the temperature of the thermal treatment at different exposing times tₑₓ to the nitrogen plasma in the MTJ device having Ta/NiFe/FeMn/NiFe/(N₂ plasma processing)/Al (1.32 nm) and oxide/NiFe/Au.

Referring to FIG. 8A, before the thermal treatment (0° C.), when the exposing time tₑₓ is 0 second, the MR ratio is about 10%, and when the exposing time tₑₓ is 10 seconds, the MR ratio is about 3%. In a case where the thermal treatment is performed at 180° C., when the exposing time tₑₓ is 0 second, the MR ratio is 14˜16%, when the exposing time tₑₓ is 10 seconds, the MR ratio is 12˜13%, when the exposing time tₑₓ is 30 seconds, the MR ratio is about 11%, and when the exposing time tₑₓ is 60 seconds, the MR ratio is about 10%. Also, in a case where the thermal treatment is performed at 230° C., when the exposing time tₑₓ is 60 seconds, 30 seconds, 10 seconds, and 0 second, respectively, the MR ratio increases from 13 to 17% by degrees. However, in a case where the thermal treatment is performed at a higher temperature than 230° C., the MR ratio is degraded irrespective of the exposure time tₑₓ to the nitrogen plasma.

In particular, when the exposure time tₑₓ is 60 seconds and the temperature of the thermal treatment increases from 0 to 180° C., the MR ratio is highly increased from about 0 to about 10%. Then, when the temperature increases up to 230° C., the MR ratio is increased up to more than 14%. Accordingly, it can be seen that the nitrogen plasma processing degrades the characteristics of the MR ratio while the thermal treatment improves them. This change is similar to that of the case where the exposure time tₑₓ is 10 seconds or 30 seconds.

Referring to FIG. 8B, when the temperature of the thermal treatment increases from 0 to 180° C., the change of the RA value is similar to that of the MR ratio. However, when the thermal treatment is performed at 230° C., the RA value is decreased a little more. In a case where the exposing time tₑₓ is 60 seconds and the temperature of the thermal treatment is increased from 0 to 180° C., the RA value increases from 20 to 40 kΩμm². Then, when the temperature is increased up to 230° C., the RA value decreases again to 30 kΩμm², and when the temperature is increased up to 250° C. or higher, the RA value decreases more to 20 kΩμm². That is, in the MTJ device according to the embodiment of the present invention, it can be seen that the nitrogen plasma processing degrades the characteristics of the RA value while the thermal treatment improves them.

FIG. 9 is a graph showing a change in binding energy before an MTJ device including Ta/NiFe/FeMn/NiFe/Fe is processed with nitrogen plasma and after the MTJ device is exposed to the nitrogen plasma for 30 seconds.

In a case where an exposing time tₑₓ is 30 seconds, the binding energy has a peak at 395˜398 eV where no peak is shown when the exposing time tₑₓ is 0 second. That is, after the MTJ device is exposed to the nitrogen plasma, AlN and/or FeN are generated. Therefore, the MTJ device including Ta/NiFe/FeMn/NiFe/Fe is processed with the nitrogen plasma, thus forming an MTJ device including Ta/Ni Fe/FeMn/NiFe/FeN/AlOₓ(1.32 nm)/NiFe/Au or Ta/Ni Fe/FeMn/NiFe/FeN/AlN/AlOₓ(10.32 nm)/Ni Fe/Au.

As explained so far, a method for fabricating an MTJ device includes depositing a pinned layer, forming a magnetoresistance buffer layer on the pinned layer by nitrogen plasma processing, depositing a tunnel barrier, a free layer, and a capping layer, and thermally treating the resultant structure. According to this method, a high-performance MTJ device with a high MR ratio and a low RA value can be fabricated. Also, because the magnetoresistance buffer layer is formed to be coupled with the tunnel barrier, the MTJ device with improved uniformity can be fabricated. As a result, sensing errors can be reduced during recording/reading of data.

While the present invention has been particularly shown and described with reference to preferred embodiments thereof, it should be appreciated that the scope of the invention is not limited to the detailed description of the invention hereinabove, which is intended merely to be illustrative, but rather comprehends the subject matter defined by the following claims. For example, those of ordinary skill in the art can fabricate a magnetoresistance buffer layer by forming another metal layer between a pinned layer and a tunnel barrier, processing the metal layer with nitrogen plasma, and thermally treating the metal layer.

What is claimed is:

1. A magnetic tunnel junction device comprising:
a substrate; and
a fixed layer, a tunnel barrier, and a free layer sequentially stacked on the substrate,
wherein a magnetoresistance buffer layer formed of a metallic nitride is interposed between the fixed layer and the tunnel barrier, and the entire magnetic tunnel junction device is thermally treated so as to reduce the magnetic junction resistance thereof.

2. The device as claimed in claim 1, wherein nitrogen is combined with elements of the tunnel barrier during the thermal treatment to form a nitrogen rich layer at the tunnel barrier.

3. The device as claimed in claim 1, wherein the fixed layer includes a seed layer, a pinning layer, and a pinned layer, which are sequentially deposited.

4. The device as claimed in claim 3, wherein the seed layer is a ferromagnetic layer formed of one selected from the group consisting of NiFe, Ru, and Ir.

5. The device as claimed in claim 3, wherein the pinning layer is a semi-ferromagnetic layer formed of one selected from the group consisting of FeMn and IrMn.

6. The device as claimed in claim 3, wherein the pinned layer is a ferromagnetic layer formed of one selected from the group consisting of NiFe and CoFe.

7. The device as claimed in claim 1, wherein the magnetoresistance buffer layer is a metallic nitride layer formed of FeN.

8. The device as claimed in claim 1, wherein the tunnel barrier is an insulating layer formed of AlOₓ.

9. The device as claimed in claim 1, wherein the thermal treatment comprises heating the magnetic tunnel junction device at a temperature of 150 to 300° C. and slowly cooling the magnetic tunnel junction device.

10. A method for fabricating a magnetic tunnel junction device comprising:
(a) depositing a fixed layer on a substrate and processing the surface of the fixed layer using nitrogen plasma;
(b) sequentially stacking a tunnel barrier, a free layer, and a capping layer on the fixed layer and thermally treating the tunnel barrier, the free layer, and the capping layer to thereby fabricate the magnetic tunnel junction device with a reduced magnetoresistance.

11. The method as claimed in claim 10, wherein the fixed layer, the tunnel barrier, the free layer, and the capping layer are deposited by sputtering.

12. The method as claimed in claim 10, wherein in (a), the nitrogen plasma processing comprises applying a direct power to a nitrogen atmosphere under a predetermined pressure to generate nitrogen plasma and bringing the nitrogen plasma into contact with the fixed layer.

13. The method as claimed in claim 10, wherein in (b), the thermal treatment comprises heating and then slowly cooling the tunnel barrier, the free layer, and the capping layer one or more times, wherein each heating is performed at a temperature between 150° C. and 300° C.

14. The method as claimed in claim 10, wherein in (b), a magnetic field is applied to the magnetic tunnel junction device during the thermal treatment.

15. The method as claimed in claim 10, wherein the thermal treatment leads nitrogen to combine with elements of the tunnel barrier.

16. The method as claimed in claim 10, wherein the fixed layer comprises a seed layer, a pinning layer, and a pinned layer, which are sequentially stacked on the substrate.

17. The method as claimed in claim 16, wherein the seed layer is a ferromagnetic layer formed of one selected from the group consisting of NiFe, Ru, and Ir.

18. The method as claimed in claim 16, wherein the pinning layer is a semi-ferromagnetic layer formed of one selected from the group consisting of FeMn and IrMn.

19. The method as claimed in claim 16, wherein the pinned layer is a ferromagnetic layer formed of one selected from the group consisting of NiFe and CoFe.

20. The method as claimed in claim 10, wherein the magnetoresistance buffer layer is a metallic nitride layer formed of FeN.

21. The method as claimed in claim 10, wherein the tunnel barrier is an insulating layer formed of AlOₓ.
